(19) United States
(12) Patent Application Publication
(10) Pub. No.: US 2013/0057472 A1
(43) Pub. Date: Mar. 7, 2013

(54) METHOD AND SYSTEM FOR A WIRELESS CONTROL DEVICE

(71) Applicants: Greg Dizac, Lausanne (CH); Marten Helwig, Wicklow (IE); Christophe Dayer, Onex (CH); David Tarongi Vanrell, Romanel sur Lausanne (CH); Nicolas Chauvin, Chexbres (CH); Florent Berney, Romanel-sur-Lausanne (CH)

(72) Inventors: Greg Dizac, Lausanne (CH); Marten Helwig, Wicklow (IE); Christophe Dayer, Onex (CH); David Tarongi Vanrell, Romanel sur Lausanne (CH); Nicolas Chauvin, Chexbres (CH); Florent Berney, Romanel-sur-Lausanne (CH)

(73) Assignee: Logitech Europe S.A., Morges (CH)

(21) Appl. No.: 13/342,752

(22) Filed: Jan. 3, 2012

Related U.S. Application Data
(60) Provisional application No. 61/532,064, filed on Sep. 7, 2011.

(51) Int. Cl. G06F 3/033

(52) U.S. Cl. 345/163

(57) ABSTRACT

A wireless control device includes a control circuit coupled to the control device, the control device having six sides and a plurality of modes of operation. Each of the plurality of modes of operation are selected by the control circuit based on the orientation of the control device as determined by an accelerometer. A first mode of operation is selected when a first side of the control device is oriented in a predetermined direction. The first mode of operation is configured to provide cursor control, a scroll function, and a side scroll function on a visual display. A second mode of operation is selected when a second side of the control device is oriented in the predetermined direction. The second mode of operation is configured to control pan and zoom functions, or control navigation and selection of media files on the visual display.

### CROSS-REFERENCES TO RELATED APPLICATIONS

The present non-provisional application claims benefit under 35 U.S.C. §120 of U.S. Provisional Patent Application No. 61/532,064, filed on Sep. 7, 2011, and entitled “Method and System for a Wireless Control Device,” which is herein incorporated by reference in its entirety for all purposes.

### BACKGROUND OF THE INVENTION

Wireless control devices, including computer mice, provide a means for interacting with a computer. As an example, a mouse can detect two-dimensional motion relative to its supporting surface and be used to move a cursor across a computer screen and provide for control of a graphical user interface. Buttons are typically provided on wireless control devices to enable a user to perform various system-dependent operations. Despite the developments related to wireless control devices, there is a need in the art for improved methods and systems related to such control devices.

### SUMMARY OF THE INVENTION

A wireless control device includes a control circuit coupled to the control device, the control device having six sides and a plurality of modes of operation, where each of the plurality of modes of operation are selected by the control circuit based on the orientation of the control device as determined by an accelerometer, according to an embodiment of the invention. A first mode of operation is selected when a first side of the control device is oriented in a predetermined direction, where the first mode of operation is configured to provide cursor control, a scroll function, a zoom function, and a side scroll function on a visual display. A second mode of operation is selected when a second side of the control device is oriented in the predetermined direction, where the second mode of operation is configured to control pan and zoom functions, and control the navigation and selection of images on the visual display. A third mode of operation is selected when a third side of the control device is oriented toward the predetermined direction, where the third mode of operation is configured to control a magnitude of a parameter on a media player, wherein the magnitude of the parameter is controlled by rotating the control device around a vertical axis passing through the third side. In an embodiment, the control device further comprises a switch configured to control at least one of a at least one of a play function, a pause function, a forward control function, and a backward control in a media player. A fourth mode of operation is selected when a user picks up the control device, where the fourth mode of operation is configured to provide display controls for a digital slide presentation. In another embodiment of the invention, the control device includes at least one of an accelerometer, a magnetometer, a gyroscope, or the like for detecting the orientation of the control device.

### BRIEF DESCRIPTION OF THE DRAWINGS

FIG. 1 is a simplified schematic diagram of a computer system according to an embodiment of the present invention.

FIG. 2 is a simplified block diagram of a multi-modal input device according to an embodiment of the present invention.

FIG. 3 is a simplified block diagram of a system configured to operate the multi-modal input device according to an embodiment of the invention.

FIG. 4A is a simplified diagram illustrating aspects of a mode of operation for the multi-modal input device according to an embodiment of the invention.

FIG. 4B is a simplified diagram illustrating aspects of a mode of operation for the multi-modal input device according to an embodiment of the invention.

FIG. 4C is a simplified diagram illustrating aspects of a mode of operation for the multi-modal input device according to an embodiment of the invention.

FIG. 4D is a simplified diagram illustrating aspects of a mode of operation for the multi-modal input device according to an embodiment of the invention.

FIG. 4E is a simplified diagram illustrating aspects of a mode of operation for the multi-modal input device according to an embodiment of the invention.

FIG. 5A is a simplified diagram illustrating aspects of a mode of operation for the multi-modal input device according to an embodiment of the invention.

FIG. 5B is a simplified diagram illustrating aspects of a mode of operation for the multi-modal input device according to an embodiment of the invention.

FIG. 6 is a simplified diagram illustrating aspects of a mode of operation for the multi-modal input device according to an embodiment of the invention.

FIG. 7A is a simplified diagram illustrating aspects of a mode of operation for the multi-modal input device according to an embodiment of the invention.

FIG. 7B is a simplified diagram illustrating aspects of a mode of operation for the multi-modal input device according to an embodiment of the invention.

FIG. 8A is a simplified diagram illustrating aspects of a mode of operation for the multi-modal input device according to an embodiment of the invention.

FIG. 8B is a simplified diagram illustrating aspects of a mode of operation for the multi-modal input device according to an embodiment of the invention.

FIG. 9 is a simplified flow diagram illustrating a method for switching between modes of operation for the multi-modal input device.

### DETAILED DESCRIPTION OF SPECIFIC EMBODIMENTS

Embodiments of the invention are generally directed to systems and methods for operating a multi-modal computer input device.

In certain embodiments, a wireless control device includes a control circuit coupled to the control device, the control device having six sides and a plurality of modes of operation, where each of the plurality of modes of operation are selected by the control circuit based on the orientation of the control device as determined by an accelerometer, according to an embodiment of the invention. A first mode of operation is selected when a first side of the control device is oriented in a predetermined direction, where the first mode of operation is configured to provide cursor control, a scroll function, a zoom function, and a side scroll function on a visual display. A second mode of operation is selected when a second side of the control device is oriented in the predetermined direction, where the second mode of operation is configured to control pan and zoom functions, and control the navigation and selection of images on the visual display. A third mode of operation is selected when a third side of the control device is oriented toward the predetermined direction, where the third mode of operation is configured to control a magnitude of a parameter on a media player, wherein the magnitude of the parameter is controlled by rotating the control device around a vertical axis passing through the third side. In an embodiment, the control device further comprises a switch configured to control at least one of a at least one of a play function, a pause function, a forward control function, and a backward control in a media player. A fourth mode of operation is selected when a user picks up the control device, where the fourth mode of operation is configured to provide display controls for a digital slide presentation. In another embodiment of the invention, the control device includes at least one of an accelerometer, a magnetometer, a gyroscope, or the like for detecting the orientation of the control device.

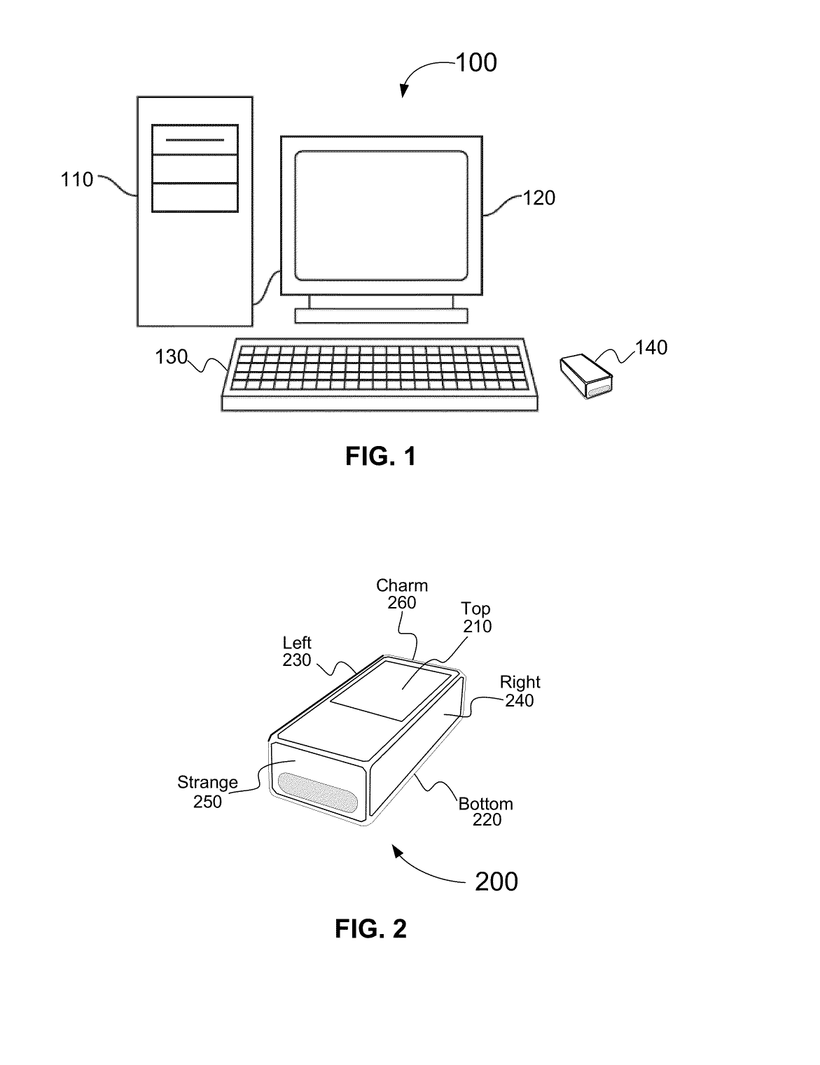

FIG. 1 is a simplified schematic diagram of a computer system 100 according to an embodiment of the present invention. Computer system 100 includes a computer 110, a monitor 120, a keyboard 130, and a control device 140. In one embodiment, the control device 140 is a multi-modal mouse control device. The control device 140 may alternatively be referred to as a multi-modal input device 140. For computer system 100, the multi-modal input device 140 and the keyboard are configured to control various aspects of computer 110 and monitor 120. In some embodiments, the multi-modal input device 140 is configured to provide control signals for page scrolling, cursor movement, selection of on screen items, media control, web navigation, presentation control, and other functionality for computer 110, as further described below. Computer 110 may include a machine readable medium (not shown) that is configured to store computer code, such as mouse driver software, keyboard driver software, and the like, where the computer code is executable by a processor (not shown) of the computer 110 to affect control of the computer by the mouse and keyboard. It should be noted that the multi-modal input device 140 may be referred to as a mouse, input device, input/output (I/O) device, user interface device, control device, and the like.

FIG. 2 is a simplified block diagram of a multi-modal input device 200, according to an embodiment of the present invention. The multi-modal input device 200 has six sides including a top side 210, a bottom side 220, a left side 230, a right side 240, a strange side 250, and a charm side 260. The multi-modal input device 200 is configured to provide a plurality of control signals and functionality to computer 110 where the particular functionality depends on physical orientation of the multi-modal input device 200 input device. For example, with bottom side 220 facing downwards, the multi-modal input device 200 may provide a first set of control signals to computer 110 (e.g., cursor control). With strange side 250 facing down, the multi-modal input device 200 may provide a second set of control signals to computer 110 (e.g., media controls), and so on.

In certain embodiments, the side facing down is the “active” side. In other words, the multi-modal input device 200 sends the control signals to the computer 110 that are associated with the side (e.g., top side 210, bottom side 220) that is concurrently facing downwards (e.g., on a surface). The multi-modal input device 200 may optionally be configured with a different active side. For example, the top side 210 may be the active side, and so on. Although the multi-modal input device 200 is described herein as a six-sided multi-modal mouse, it should be noted that other embodiments may have more sides or fewer sides. For example, the multi-modal input device 200 may be a tetrahedron (four sided polygon), octahedron (eight-sided polygon), or another polygon that may be well-suited for a particular application. In addition, the multi-modal input device 200 can include one or more curved surfaces. Thus, polygons are just exemplary shapes and the device can include one or more flat sides as well as one or more curved sides. It should be noted that although certain embodiments of this disclosure associate certain functions (e.g., cursor control) with specific sides of multi-modal input device 200, the various functions described herein may be associated with any of the sides. Certain embodiments of multi-modal input device 200 may optionally comprise combinations of functions (e.g., associating cursor control and scrolling to a particular side), use only a portion of the functions of described herein, or add additional functions.

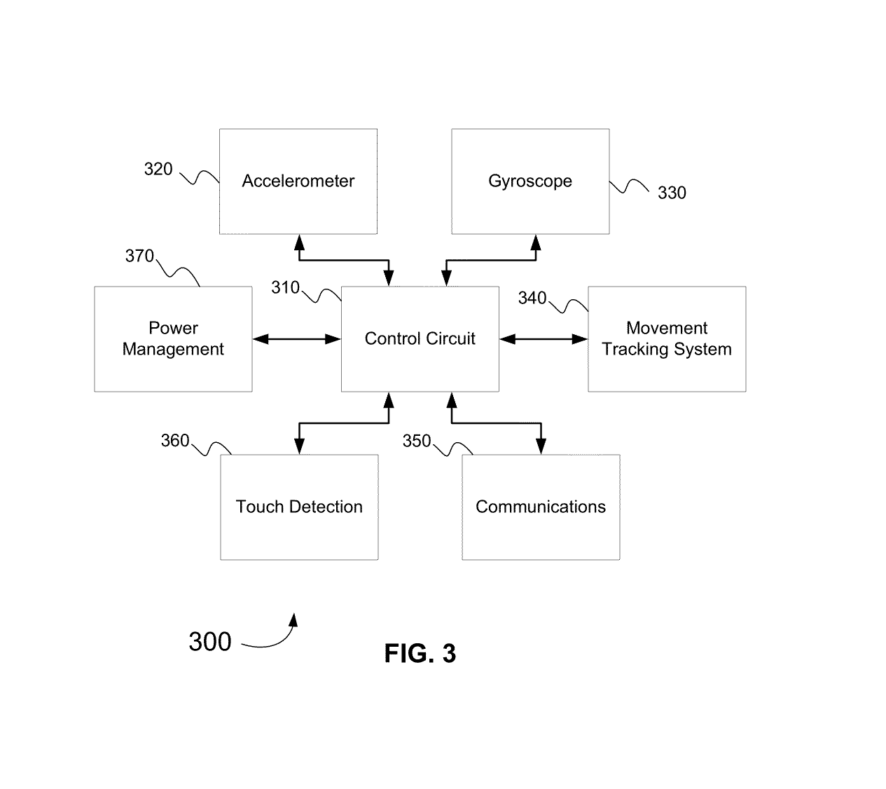

FIG. 3 is a simplified block diagram of a system 300 configured to operate the multi-modal input device 200 input device, according to an embodiment of the invention. The system 300 includes a control circuit 310, one or more accelerometers 320, one or more gyroscopes 330, a movement tracking system 340, a communications system 350, touch detection system 360, and power management block 370. Each of the system blocks 320-370 are in electrical communication with the control circuit 310. System 300 may further include additional systems that are not shown or discussed to prevent obfuscation of the novel features described herein.

In certain embodiments, the control circuit 310 comprises one or more microprocessors (μCs) and is configured to control the operation of system 300. Alternatively, the control circuit 310 may include one or more microcontrollers (MCUs), digital signal processors (DSPs), or the like, with supporting hardware/firmware (e.g., memory, programmable I/Os, etc.), as would be appreciated by one of ordinary skill in the art with the benefit of this disclosure. Alternatively, MCUs, μCs, DSPs, and the like, may be configured in other system blocks of system 300. For example, the touch detection system 360 may include a local microprocessor to execute instructions relating to a two-dimensional touch surface (e.g., touch pad 444) on the top side 210 of multi-modal input device 200. In some embodiments, multiple processors may provide an increased performance in system 300 speed and bandwidth. It should be noted that although multiple processors may improve system 300 performance, they are not required for standard operation of the embodiments described herein.

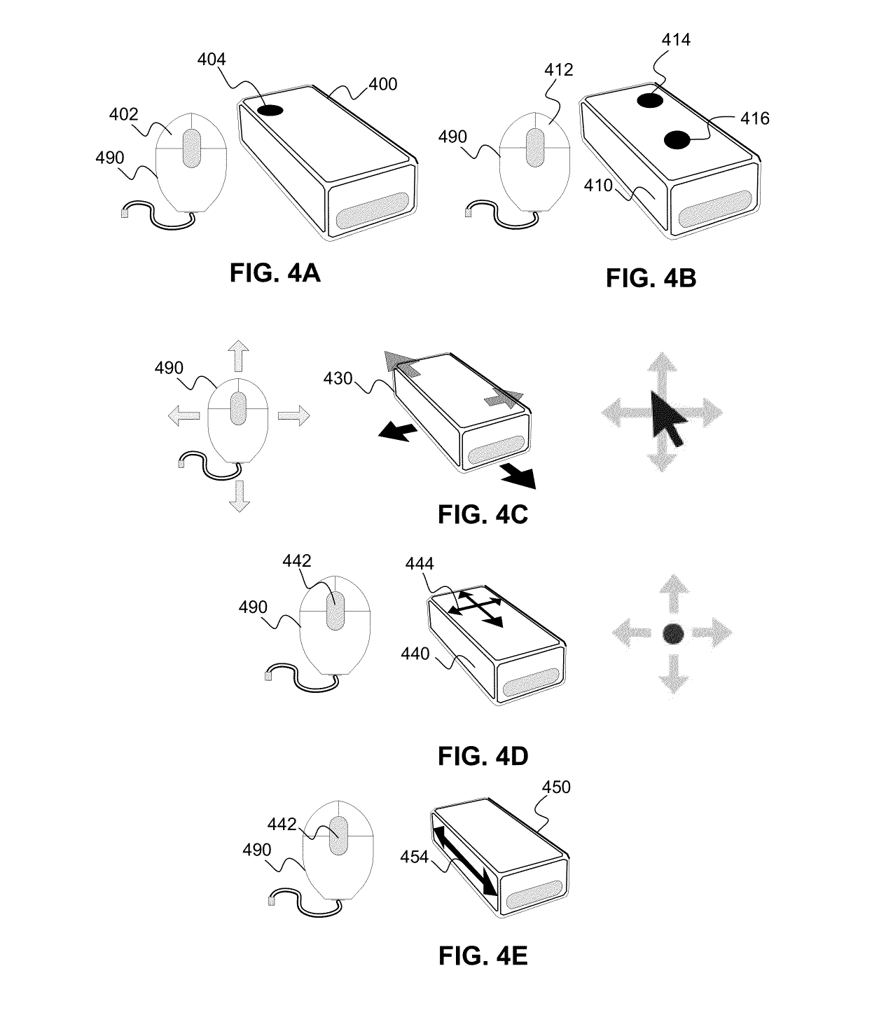

In certain embodiments, the accelerometers 320 are electromechanical devices (e.g., micro-electromechanical systems (MEMS) devices) configured to measure acceleration forces (e.g., static and dynamic forces). One or more accelerometers can be used to detect three dimensional (3D) positioning. For example, 3D tracking can utilize a three-axis accelerometer or two two-axis accelerometers. According to some embodiments, the multi-modal input device 200 utilizes a 3-axis accelerometer to detect the active face (i.e., the side facing downwards) to determine the physical orientation of the multi-modal input device 200. The active face determines the mode of operation of the system 300, as further described below with respect to FIGS. 4-9.

A gyroscope 330 is a device configured to measure the orientation of the multi-modal input device 200 and operates based on the principles of the conservation of angular momentum. In certain embodiments, the one or more gyroscopes 330 in system 300 are micro-electromechanical (MEMS) devices configured to detect a certain rotation of the multi-modal input device 200. To illustrate, the gyroscope 330 can be configured to control an audio volume of a media player based on a rotational position of the multi-modal input device 200, according to an embodiment of the invention. In other words, a user rotates the multi-modal input device 200, much like one may rotate a volume knob, to increase or decrease an audio volume. The system 300 may optionally comprise 2-axis magnetometers in lieu of, or in combination with, the one or more gyroscopes 330.

The movement tracking system 340 is configured to track a movement of the multi-modal input device 200, according to an embodiment of the invention. In certain embodiments, the movement tracking system 340 uses optical sensors such as light-emitting diodes (LEDs) and an imaging array of photodiodes to detect movement of the multi-modal input device 200 relative to an underlying surface. The multi-modal input device 200 may optionally comprise movement tracking hardware that utilizes coherent (laser) light. In certain embodiments, one or more optical sensors are disposed on the bottom side 220 of multi-modal input device 200, as described below with respect to FIG. 4. Alternatively, optical sensors may be disposed on other surfaces to enable movement tracking of the multi-modal input device 200 in other orientations. In further embodiments, the movement tracking system 340 uses other technologies (e.g., MEMS devices, etc.).

The communications system 350 is configured to provide wireless communication with the computer 110, according to an embodiment of the invention. In certain embodiments, the communications system 350 is configured to provide radio-frequency (RF) communication with other wireless devices. Alternatively, the communications system 350 can wirelessly communicate using other wireless communication protocols including, but not limited to, Bluetooth and infra-red wireless systems. The system 300 may optionally comprise a hardwired connection to the computer 110. For example, the multi-modal input device 200 can be configured to receive a Universal Serial Bus (USB) cable to provide electronic communication with external devices. Other embodiments of the invention may utilize different types of cables or connection protocol standards to effectuate a hardwired communication with outside entities. In one non-limiting example, a USB cable can be used to provide power to the multi-modal input device 200 to charge an internal battery (not shown) and simultaneously support data communication between the system 300 and the computer 110.

The touch detection system 360 is configured to detect a touch or touch gesture on one or more of the sides of the multi-modal input device 200, according to an embodiment of the present invention. In certain embodiments, the multi-modal input device 200 has two-dimensional (2D) touch detection capabilities (e.g., x-axis and y-axis movement) on the face of one or more of the surfaces. In one non-limiting example, the top side 210 has a 2D touch sensor (e.g., touch pad 444) that operates similar to that of a touch panel on a laptop computer. The multi-modal input device 200 may optionally comprise surfaces with a one-dimensional touch detection system (e.g., touch pad 454) disposed thereon.

In certain embodiments, the power management system 370 of system 300 is configured to manage power distribution, recharging, power efficiency, and the like for the multi-modal input device 200. According to some embodiments, power management system 370 includes a battery (not shown), a USB based recharging system for the battery (not shown), power management devices (e.g., low-dropout voltage regulators—not shown), an on/off slider, and a power grid within system 300 to provide power to each subsystem (e.g., accelerometers 320, gyroscopes 330, etc.). In one embodiment, the on/off slider is located on the strange side 250 of the multi-modal input device 200. It should be noted that more or fewer power management features may be used as necessary and would be appreciated by one of ordinary skill in the art with the benefit of this disclosure.

FIG. 4A is a simplified diagram illustrating aspects of a mode of operation for the multi-modal input device 400, according to an embodiment of the invention. In certain embodiments, the multi-modal input device (“multi-modal input device 400”) includes system 300 and can include similar features as those described above with respect to FIG. 2. FIG. 4A includes a multi-modal input device mouse 400, a touch location 404 on the top side 210, and a standard mouse 490. The standard mouse 490 includes a left button 402. It should be noted that the standard mouse 490 is used for illustrative purposes to describe, compare, and contrast various aspects of the present invention and should not be confused with the multi-modal input device 400 or system 300. In other words, standard mouse 490 is separate and distinct from the various embodiments described herein. FIG. 4A depicts the multi-modal input device 400 in a “mouse” mode of operation. In other words, the multi-modal input device 400, as oriented in FIG. 4A, is configured to perform a plurality of mouse functions (e.g., left-click, right-click, cursor movement, etc.) while in this particular mode of operation.

In certain embodiments, the multi-modal input device 400 executes a “left-click” function similar to the left click 402 of standard mouse 490 when a user touches the touch location 404 on top side 210. Alternatively, the touch location 404 may be disposed in other locations on top side 210. In some embodiments, the touch location 404 is user-assignable and controlled by software (e.g., device drivers). Furthermore, the functional touch area in some embodiments can be larger or smaller than touch location 404. For example, the entire left portion of top side 210 may function as a left-click button. In other embodiments, the “left-click” function may be assigned to a different surface or location on the multi-modal input device 400 (not shown). For example, the “left-click” function can be assigned to a location on the left side 230 of multi-modal input device 400. Alternatively, some embodiments may register a “left-click” when the touch location 404 is double clicked. Further embodiments may include a push button disposed on the multi-modal input device 400 to effectuate a left-click.

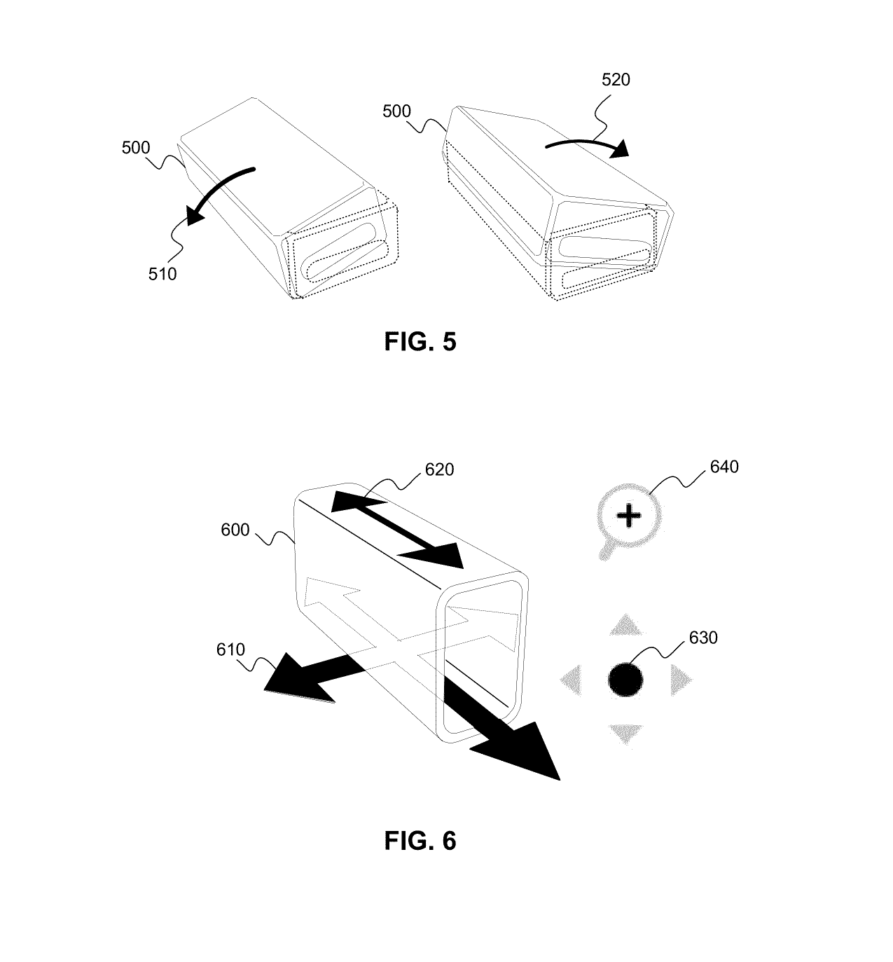

In some embodiments, the active side of the multi-modal input device 400 is determined by the side concurrently facing downwards. For example, the “mouse mode” of multi-modal input device 400 is activated when the bottom side 210 is facing downward. Alternatively, the active side can be the side that is facing upwards, sideways, or the like. In some embodiments, the accelerometer 320 and control circuit 310 are configured to determine the orientation of multi-modal input device 400. In certain embodiments, the multi-modal input device 400 can perform some or all of the various “mouse mode” functions described in FIGS. 4A-4E and FIG. 5.

FIG. 4B is a simplified diagram illustrating aspects of a mode of operation for the multi-modal input device 410, according to an embodiment of the invention. In certain embodiments, the multi-modal input device 410 includes system 300 and can include similar features as those described above with respect to FIG. 2. FIG. 4B includes multi-modal input device 410, touch locations 414 and 416 on the top side 210, and a standard mouse 490. The standard mouse 490 includes a right button 412. It should be noted that the standard mouse 490 is used for illustrative purposes to describe, compare, and contrast various aspects of the present invention and should not be confused with the multi-modal input device 410 or system 300. In other words, standard mouse 490 is separate and distinct from the various embodiments described herein. multi-modal input device 410, as shown, is configured in the “mouse” mode of operation.

In certain embodiments, the multi-modal input device 410 executes a “right-click” function similar to a right click 412 of standard mouse 490 when a user touches the touch location 414 on top side 210. In some embodiments, touch location 416 is used to execute a “right-click.” Multi-modal input device 410 can be further configured to include one or both touch locations 414 and 416. Alternatively, touch locations 414, 416 may be disposed in other places on the top side 210. In some embodiments, the functional touch area can be larger or smaller than touch location 414 and 416. For example, the entire right portion of the top side 210 may be configured to function as a right-click. The multi-modal input device 410 may optionally be configured with a right-click function assigned to a different side. For example, the right-click function can be assigned to a location on the right side 240 of multi-modal input device 410 (not shown). In some embodiments, the touch locations 414, 416 are user-assignable and controlled by software (e.g., device drivers). Further embodiments of multi-modal input device 410 can include a push button disposed on the multi-modal input device 410 to effectuate a right-click.

In certain embodiments, the active side of the multi-modal input device 410 is determined by the side concurrently facing downwards. For example, the “mouse mode” of multi-modal input device 410 is activated when the bottom side 210 is facing downward. Alternatively, the active side can be the side that is facing upwards, sideways, or the like. In some embodiments, the accelerometer 320 and control circuit 310 are configured to determine the orientation of multi-modal input device 410. In certain embodiments, the multi-modal input device 410 can perform some or all of the various “mouse mode” functions described in FIGS. 4A-4E and FIG. 5.

FIG. 4C is a simplified diagram illustrating aspects of a mode of operation for the multi-modal input device 430, according to an embodiment of the invention. In certain embodiments, the multi-modal input device 430 includes system 300 and can include similar features as those described with respect to FIG. 2. FIG. 4C includes multi-modal input device 430 and standard mouse 490. The multi-modal input device 430 further includes a movement tracking system disposed on the bottom side 220 (not shown). It should be noted that the standard mouse 490 is used for illustrative purposes to describe, compare, and contrast various aspects of the present invention and should not be confused with the multi-modal input device 430 or system 300. In other words, standard mouse 490 is separate and distinct from the various embodiments described herein. Multi-modal input device 430, as shown, is configured in the “mouse” mode of operation. In certain embodiments, the multi-modal input device 430 can perform some or all of the various “mouse mode” functions described in FIGS. 4A-4E and FIG. 5.

In certain embodiments, the multi-modal input device 430 is configured to control a cursor movement on a monitor 120 similar to the cursor control function executable by a standard mouse 490. In other words, moving the multi-modal input device 430 in the mouse mode along a surface causes cursor to move on a monitor (e.g., along an x- and y-axis). For example, moving the multi-modal input device 430 forward can cause a cursor to move in an upward direction on a monitor 120.

In certain embodiments, the active side of the multi-modal input device 430 is determined by the side concurrently facing downwards. For example, the “mouse mode” of multi-modal input device 410 is activated when the bottom side 210 is facing downward. Alternatively, the active side can be the side that is facing upwards, sideways, or the like. In some embodiments, the accelerometer 320 and control circuit 310 are configured to determine the orientation of multi-modal input device 430.

The movement tracking system 340 is configured to detect movement of the multi-modal mouse 430 in the “mouse mode” of operation. In certain embodiments, the movement tracking system 340 can include an optical sensor system (e.g., LEDs and photo-diodes) configured to detect the movement of multi-modal input device 430 relative to an underlying surface. In further embodiments, movement tracking can be detected by a laser light system. Alternatively, the accelerometer 320 can be used for movement detection. It should be noted that movement track systems (e.g., optical sensors) may be disposed on multiple surfaces of multi-modal input device 430 to allow movement tracking in other orientations and/or modes of operation.

FIG. 4D is a simplified diagram illustrating aspects of a mode of operation for the multi-modal input device 440, according to an embodiment of the invention. In certain embodiments, the multi-modal input device 440 includes system 300 and can include similar features as those described above with respect to FIG. 2. FIG. 4D includes multi-modal input device mouse 440 and a standard mouse 490. In some embodiments, the multi-modal input device 440 includes a touch pad 444. The standard mouse 490 includes a scroll wheel 442. It should be noted that the standard mouse 490 is used for illustrative purposes to describe, compare, and contrast various aspects of the present invention and should not be confused with the multi-modal input device 440 or system 300. In other words, standard mouse 490 is separate and distinct from the various embodiments described herein. multi-modal input device 440, as shown, is configured in the “mouse” mode of operation. In certain embodiments, the multi-modal input device 440 can perform some or all of the various “mouse mode” functions described in FIGS. 4A-4E and FIG. 5.

In certain embodiments, the multi-modal input device 440 is configured to execute various scrolling functions similar to a typical scroll function performed on a standard mouse 490. A standard mouse 490 can typically scroll a document or webpage viewed on a monitor 120 by rotating a scroll wheel 442 upwards or downwards. In certain embodiments, the multi-modal input device 440 executes a similar up-down scroll function when a user swipes a finger forwards or backwards on the touch pad 444. In further embodiments, a swipe gesture from side to side initiates a left-right scroll function. For example, a swipe gesture from the left to right side of touch pad 444 will initiate a left-to-right scroll on the document, webpage, or the like. The touch pad 444 can be disposed along the top portion of top side 210. Alternatively, the touch pad 444 can be disposed along the entire top side 210. Up-down and side-to-side gestures can be detected on any portion of the touch pad 444. In further embodiments, additional touch pads (not shown) can be disposed on the other sides of multi-modal input device 440 and can be configured to execute similar scrolling functions. In certain embodiments, the touch pad 444 is a capacitive touch sensor utilizing self-capacitance, mutual-capacitance, or a combination of both to detect a touch. Other touch sense technologies may be used (e.g., resistive touch sensors) and are known and appreciated by those of ordinary skill in the art.

The touch pad 444 can optionally control a zoom function. In some embodiments, an up-down swipe gesture on touch pad 444 can increase or decrease the magnification of a document, web page, or the like. Alternatively, the multi-modal input device 440 can be configured to execute both scroll function and zoom functions. To illustrate, the touch pad 444 can be configured to execute a scroll function when a user performs a swipe gesture on the touchpad 444, and a zoom function when the user performs a swipe gesture in conjunction with depressing a key on a keyboard 130 or other input device. In some embodiments, a zoom function is executed when a user depresses the control key on a keyboard and simultaneously swipes up or down on the touch pad 444.

In certain embodiments, the active side of the multi-modal input device 440 is determined by the side concurrently facing downwards. For example, the “mouse mode” of multi-modal input device 440 is activated when the bottom side 220 is facing downward. Alternatively, the active side can be the side that is facing upwards, sideways, or the like. In some embodiments, the accelerometer 320 and control circuit 310 are configured to determine the orientation of multi-modal input device 440.

FIG. 4E is a simplified diagram illustrating aspects of a mode of operation for the multi-modal input device 450, according to an embodiment of the invention. In certain embodiments, the multi-modal input device 450 includes system 300 and can include similar features as those described above with respect to FIG. 2. FIG. 4E includes multi-modal input device mouse 450 and a standard mouse 490. In some embodiments, the multi-modal input device 440 includes a touch pad 454 on the left side 230. The standard mouse 490 includes a scroll wheel 442. It should be noted that the standard mouse 490 is used for illustrative purposes to describe, compare, and contrast various aspects of the present invention and should not be confused with the multi-modal input device 450 or system 300. In other words, standard mouse 490 is separate and distinct from the various embodiments described herein. Multi-modal input device 450, as shown, is configured in the “mouse” mode of operation. In certain embodiments, the multi-modal input device 450 can perform some or all of the various “mouse mode” functions described in FIGS. 4A-4E and FIG. 5. In some embodiments, the accelerometer 320 and control circuit 310 are configured to determine the orientation of multi-modal input device 450.

In certain embodiments, the multi-modal input device 450 is configured to execute various scrolling functions similar to a typical scroll function performed on a standard mouse 490. A standard mouse 490 can typically scroll a document or webpage viewed on a monitor 120 by rotating a scroll wheel 442 upwards or downwards. In certain embodiments, the multi-modal input device 450 executes a similar up-down scroll function when a user performs a swipe gesture forwards or backwards on the touch pad 454. Alternatively, the multi-modal input device 450 can be configured to perform a left-right scroll function or a zoom function. The touch pad 454 is located on the left side 230. The touch pad 454 may optionally be disposed on the right side 240, or on both sides 230, 240.

FIG. 5 is a simplified diagram illustrating aspects of a mode of operation for the multi-modal input device 500, according to an embodiment of the invention. Multi-modal input device 500 is configured to detect a left tilt gesture 510 (i.e., when a user tilts multi-modal input device 500 towards the left side 230) or a right tilt gesture 520 (i.e., when a user tilts the multi-modal input device 500 towards the right side 240) from a bottom side 220 active resting position (i.e., the “mouse mode” of operation). In certain embodiments, the amount of tilt required (i.e., tilt angle threshold) to trigger the detection of a left tilt 510 or right tilt 520 is fully programmable and can range from approximately 5 degrees to 85 degrees. The multi-modal input device 500 may optionally comprise a default tilt detection angle. In certain embodiments, the default tilt angle threshold depends on the face of the multi-modal input device currently in use. For some embodiments, the tilt threshold is approximately 10 degrees to exit the strange face 250, 22.5 degrees to exit the right 240, left 230, and charm 260 faces, and 67.5 degrees for top 210 and bottom 220 faces. In further embodiments, the accelerometer 320, in conjunction with the control circuit 310, detects the tilt angle thresholds. Alternatively, the gyroscope 330 or a magnetometer (not shown) can detect the tilt angle thresholds. Multi-modal input device 500, as shown, is configured in the “mouse” mode of operation. The multi-modal input device 500 includes system 300 and can include similar features as those described above with respect to FIG. 2. In certain embodiments, the multi-modal input device 500 can perform some or all of the various “mouse mode” functions described in FIGS. 4A-4E and FIG. 5. In some embodiments, the accelerometer 320 and control circuit 310 are configured to determine the orientation of multi-modal input device 500.

In certain embodiments, the tilt gestures 510, 520 can be configured to execute web page controls. For example, a left tilt gesture 510 may be configured to perform a web browser “back” function where a web browser navigates to a previously viewed web page. Similarly, a right tilt gesture 520 may function as a web browser “forward” or “next page” function. Alternatively, the tilt gestures 510, 520 may be configured to perform media browsing controls. To illustrate, a left tilt gesture 510 may be configured to display a previous digital photo in a series of photos and a right tilt gesture 520 may display the next digital photo in the series of photos. In some embodiments, performing multiple tilt gestures in succession require the user to return the multi-modal input device 500 to the starting position (e.g., bottom side 220 active orientation) before performing the next tilt gesture.

FIG. 6 is a simplified diagram illustrating aspects of a mode of operation for the multi-modal input device 600, according to an embodiment of the invention. FIG. 6 includes multi-modal input device mouse 600 and touch sensor 620 disposed on the right side 240. The multi-modal input device 600, as shown, operates in a “picture” mode when the right side 240 is active (i.e., left side 230 facing downwards). In other words, the multi-modal input device 600, as oriented in FIG. 6, is configured to perform a plurality of image and/or web page control functions (e.g., browse, pan, zoom, etc.) while in this particular mode of operation. The multi-modal input device 600 includes system 300 and can include similar features as those described above with respect to FIG. 2. In certain embodiments, the multi-modal input device 600 may have a touch sensor on the left side 230 or on both sides (not shown).

In some embodiments, the touch sensor 620 functions as a one-dimensional slider configured to perform zoom 640 and scrolling functions on internet web pages or various media. For example, sliding a finger up or down the touch sensor 620 may enlarge or reduce (i.e. zoom) the size of a digital image on a monitor 120. Alternatively, sliding a finger up or down touch sensor 620 may scroll the digital image or webpage up or down (not shown), similar to the scroll wheel 452 of mouse 490 described above with respect to FIG. 4E. It should be noted that even though touch sensor 620 and touch sensor 454 may be the same physical touch sensing device, they each function according to the current mode of operation (i.e., active side). For example, the touch sensor 620 of multi-modal input device 600 (i.e., in a picture mode) may perform a zoom function while touch sensor 454 in the mouse mode may perform a scroll function, or vice versa.

In certain embodiments, the multi-modal input device 600 is further configured to track movement along a two-dimensional axis 610 while oriented in the picture mode (e.g., right side 240 active). For example, moving the multi-modal input device 600 along the two-dimensional axis 610 may execute a panning function 630 on a digital image or an internet web page. In an embodiment, the accelerometer 320 detects the movement along the two-dimensional axis 610. It should be noted that although the embodiment shown in FIG. 6 depicts a “left-side active 230” orientation, a “right-side active 240” orientation may be configured to perform the same or substantially the same functions. In some embodiments, the accelerometer 320 and control circuit 310 are configured to determine the orientation of multi-modal input device 600.

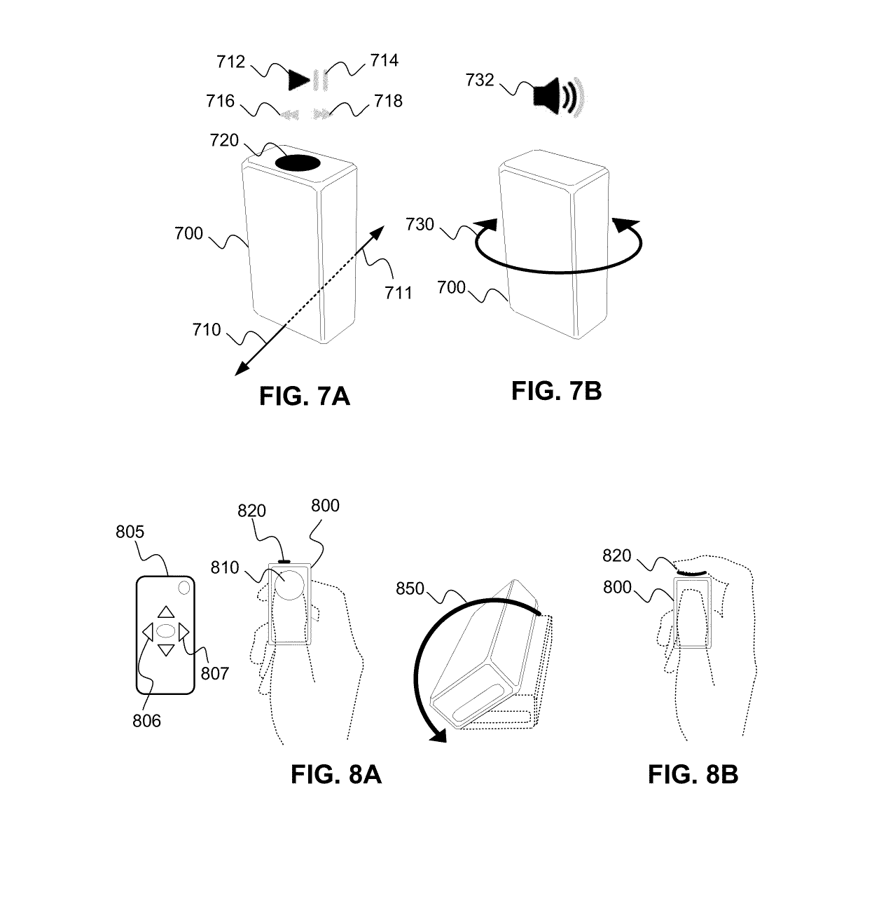

FIGS. 7A and 7B are simplified diagrams illustrating aspects of a mode of operation for the multi-modal input device 700, according to an embodiment of the invention. A “media controller mode” is selected when the strange side 250 is configured in the active mode (i.e., the charm side 260 is facing upwards). The media controller mode of operation is configured to perform a plurality of media control functions (e.g., play/pause, volume control, next/previous track selection, etc.). In certain embodiments, multi-modal input device 700 includes button 720. The multi-modal input device 700 further includes system 300 and the features of multi-modal input device 200, as described above with respect to FIG. 2. The accelerometer 320, in conjunction with the control circuit 310, can detect the orientation of multi-modal input device 700 (e.g., strange side 250 active).

According to certain embodiments, depressing button 720 causes a media player to play 712 or pause 714 a media file. The media files may be audio, video, or both. In some embodiments, button 720 toggles between play 712 and pause 714. Alternatively, there may be more than one button 720 where each button has a dedicated function (e.g., button 720 executes a play 712 function and the second button (not shown) executes a pause 714 function). Typically, the button 720 is a push button utilizing a simple switch mechanism to complete or disconnect an electrical circuit. Button 720 may optionally be a touch sensor, similar to the touch pad 454 described above with respect to FIG. 4D.

In some embodiments, the media controller mode provides “next track” 718 and “previous track” 716 functions based certain lateral movements 710, 711 of multi-modal input device 700. For example, moving the multi-modal input device 700 in a lateral direction 710 can cause a media player running on computer system 100 to execute a “previous track” 716 selection. Similarly, moving the multi-modal input device 700 in the lateral direction 711 can cause the media layer to execute a “next track” 718 selection. Although FIG. 7 depicts linear movement detection, certain embodiments can detect movement in any number of directions (e.g., left, right, forwards, backwards, etc.). Furthermore, movement-based selections placed while in the media controller mode are not limited to track selections and may perform an audio mute function, cycle through equalization presets, open media libraries, or perform other functions commonly associated with media players.

The multi-modal input device 700 can provide volume control on a media player by rotating 730 the multi-modal input device 700 on its base (e.g., strange side 250 down), similar to a volume knob on a stereo. For example, rotating 730 the multi-modal input device 700 to the left can lower the volume 732 on a media player. Similarly, rotating 730 the multi-modal input device 700 to the right can raise the volume 732 on the media player. According to an embodiment, the gyroscope 330, in conjunction with control circuit 310, can detect the rotation of the multi-modal input device 700. In certain embodiments, a 3-axis gyroscope can be used to detect the rotation of the multi-modal input device 700. Alternatively, a 3-axis accelerometer can also be used to detect the device rotation.

Multi-modal input device 700 may optionally provide additional functionality when button 720 is depressed for a predetermined period of time (e.g., 1 or more seconds). In addition to the single click functions (e.g., play 712 and pause 714) described above, button 720 can toggle additional functions controlled by the rotation 730 of multi-modal input device 700. For example, depressing button 720 for longer than the predetermined period of time can cause multi-modal input device 700 to toggle between different rotation-based functions including volume control, fader control, audio panning control, bass/treble control, and the like. In some embodiments, once the button 720 is pressed longer than the predetermined period of time, successive button 720 clicks will cycle through the different rotation-based functions. According to certain embodiments, successively depressing the button 720 for the predetermined period of time can toggle the function of button 720 between a play 712/pause 714 selection mode and a rotation control selection mode. In some embodiments, the predetermined period of time may be user selected (e.g., by software based drivers) or factory set.

FIGS. 8A and 8B are simplified diagrams illustrating aspects of a mode of operation for the multi-modal input device 800, according to an embodiment of the invention. The multi-modal input device 800 is placed in a “presentation mode” when lifted in the air (i.e., lifted off of a surface). The presentation mode allows a user to perform functions similar to that of a standard presentation remote controller 805 (e.g., select previous/next slide, and toggle full screen and blank screen display) as described below. FIG. 8A includes both a multi-modal input device 800 and a typical remote control device 805. In some embodiments, the multi-modal input device 800 includes buttons 810 and 820. The remote control 805 includes a buttons 806 and 807. It should be noted that the remote controller 805 is used for illustrative purposes to describe, compare, and contrast various aspects of the present invention and should not be confused with the multi-modal input device 800 or system 300. In other words, remote controller 805 is separate and distinct from the various embodiments described herein. Multi-modal input device 800 further includes system 300 and can include similar features as those described above with respect to FIG. 2. In certain embodiments, buttons 810 and 820 are the same as touch panel 444 of FIG. 4D and button 720 of FIG. 7A, respectively.

To help illustrate some of the functions of the presentation mode of the multi-modal input device 800, a typical remote control 805 is described. A typical remote control device 805 can be used to control a display in a slide presentation (e.g., in a Microsoft™ Powerpoint presentation). For example, pressing a “forward” button 807 on remote control 805 can cause the next slide in a series of slides to be selected. Similarly, pressing a “back” button 806 can cause a previous slide in a series of slides to be selected. In certain embodiments, the multi-modal input device 800 can perform similar functions when placed in the presentation mode. For example, a next slide in a presentation can be selected when a user presses button 810 on the multi-modal input device 800 (i.e., with the bottom side 210 substantially parallel with the floor). This can be referred to as a first presentation mode. A previous slide can be selected when a user flips (850) the multi-modal input device 800 over by approximately 180 degrees and presses the same button 810 (i.e., with the top side 210 substantially parallel with the floor). This can be referred to as a second presentation mode. In other words, the system 300 can detect when the multi-modal input device 800 is flipped over in the second presentation mode and reassigns button 810 from a “next slide” function to a “previous slide” function. Similarly, the system 300 reassigns button 810 from the “previous slide” function back to the “next slide” function when the multi-modal input device 800 is flipped back to the first presentation mode. In some embodiments, the “previous slide” and “next slide” functions can be referred to as “page up” and “page down” functions, respectively.

The multi-modal input device 800 is further configured to account for the natural movement that may occur when a user uses multi-modal input device 800 in the presentation modes. For example, it is unlikely that a user would hold the multi-modal input device 800 exactly parallel to the ground surface in the first or second presentation mode. To compensate for slightly off-center orientations, the multi-modal input device 800 remains in the first or second presentation mode until a predetermined angle of rotation is reached, according to an embodiment of the invention. In other words, the first presentation mode will remain in the first presentation mode until a user flips 850 the multi-modal input device 800 beyond a predetermined angle of rotation. In some embodiments, the predetermined angle of rotation is approximately plus or minus 40 degrees. Similarly, the second presentation mode will remain in the second presentation mode until a user flips 850 the multi-modal input device 800 beyond the predetermined angle of rotation.

In some embodiments, the multi-modal input device 800 is configured to toggle between a full screen display and a blank screen display when placed in either of the first or second presentation modes. As shown in FIG. 8B, the multi-modal input device 800 toggles between full screen and blank screen when a user presses button 820. In an embodiment, button 820 performs the same function in either the first or second presentation mode.

As described above, the presentation mode is selected when a user lifts the multi-modal input device 800 from a surface. It should be noted that the multi-modal input device 800 can perform lift detection from any orientation or mode of operation. For example, lifting the multi-modal input device 800 in the air from a mouse mode (e.g., top side 210 active), picture mode (e.g., right side active), or media control mode (e.g., charm side 260 active) will activate the presentation mode. The multi-modal input device 800 (i.e., system 300) performs lift detection with the combination of the movement tracking system 340, accelerometer 320, and the control circuit 310. Lift detection would be known and appreciated by one of ordinary skill in the art with the benefit of this disclosure.

In some embodiments, when a user launches the presenter mode of operation, the multi-modal input device 800 can maintain the presentation mode until further explicit reverse action is executed by the user. One method of reverting back to the mouse mode of operation is turning the unit off and subsequently turning it back on. Another method can include reverting back to mouse mode by software interaction (e.g., on-screen menu with button to revert to mouse mode). In other embodiments, the presentation mode of operation reverts to the mouse mode of operation when the multi-modal input device 800 is placed on a surface and receives no user input for a predetermined period of time. For example, if a user places the multi-modal input device 800 on a table while in presenter mode, the multi-modal input device 800 may revert back to mouse mode after 10 minutes have elapsed with no user input (or any other desired predetermined period of time). In some embodiments, when in the presentation mode, the multi-modal input device 800 can be ported to a second computer (with any installed multi-modal input device 800 drivers) and still function in the presentation mode for the second computer. This feature may apply to the other modes of operation (e.g., mouse mode) as well. Furthermore, the various mode assignments (e.g., presentation mode, mouse mode, etc) can be stored in firmware only, software only, or a combination thereof.

According to certain embodiments, the presentation mode of operation can include the following assignments: pointer movement and scrolling disabled, left-click button mapped to “next slide” (e.g., when bottom side 220 is facing down) or “previous slide” function (e.g., when top side 210 is facing down), tapping button 820 toggles blank screen, and double tapping button 820 toggles a full screen mode.

The multi-modal input device 800 may include an on-screen display function when switching from one orientation to another. For example, when orienting the multi-modal input device 800 from “mouse mode” to “picture mode,” an on-screen graphic (e.g., transparent line drawing) can display an image or animation showing the change in orientation. This may help the user identify when the multi-modal input device 800 has changed from one orientation by providing a visual confirmation that the multi-modal input device 800 has switched modes of operation.

In some embodiments, a user can customize a variety of operational settings for the multi-modal input device 800. For example, a user can alter the pointer speed, acceleration, and scrolling speed. A user can further enable/disable touch scrolling, 2-finger click for right click, back/forwards gesture, volume control through rotation in vertical position (“media mode”), play/pause toggle in media mode by button 820, and the like. Some embodiments may include three options for the right click function including clicking with one finger in the upper-right hand corner of the touch sensor (default), click 2 fingers at the same time on touch sensor, or no assignment where a right click function will not be performed. In other embodiments, tapping the touch sensor can be assigned to a custom keystroke or other function when in the presentation mode of operation. It should be noted that the multi-modal input device 800 can be customized in any number of ways with different combinations of functionality for each of the control features (e.g., orientations, buttons, etc.).

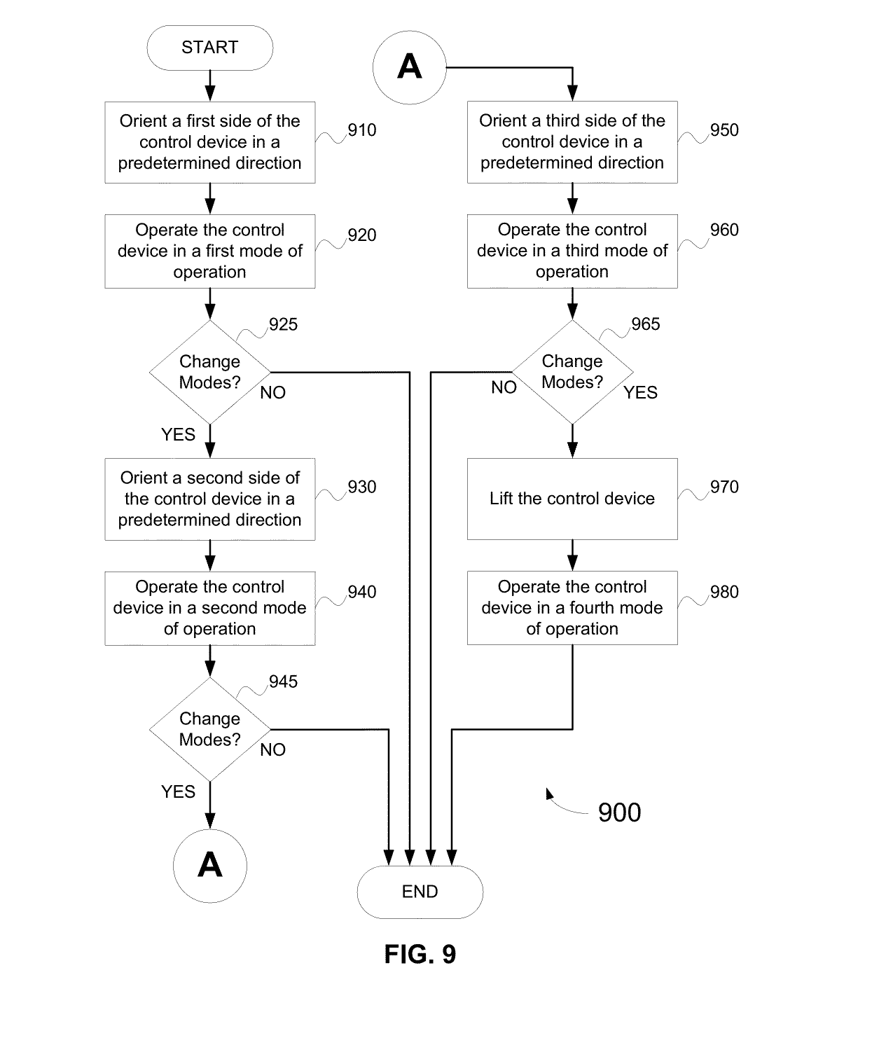

FIG. 9 is a simplified flow diagram illustrating a method 900 for switching between modes of operation for the multi-modal input device 200. The method 900 is performed by processing logic that may comprise hardware (circuitry, dedicated logic, etc.), software (such as is run on a general purpose computing system or a dedicated machine), firmware (embedded software), or any combination thereof. In one embodiment, the method 900 is performed by system 300 of FIG. 3.

Referring to FIG. 9, the method 900 includes orienting a first side of the multi-modal input device 200 control device in a predetermined direction (910). The predetermined direction designates the “active side.” Typically, the active side is the side facing the bottom surface of multi-modal input device 200. In an embodiment, the first side of the multi-modal input device 200 is the bottom side 220 in the active configuration, or the first mode of operation. The bottom side 220 active can be referred to as the “mouse mode.” In other words, when the bottom side 220 is active, the user can perform various mousing functions including left and right clicks, cursor movement, scrolling, and the like. The mouse mode of operation is described above with respect to FIGS. 4A-4E and 5.

The user operates the multi-modal input device 200 in the first mode of operation (920). In an embodiment, the first mode of operation is the mouse mode with bottom side 220 active. A user can change the mode of operation by changing the orientation of the multi-modal input device 200 (925). To illustrate, a user may change (925) from the mouse mode (e.g., the first mode of operation) to the media controller mode (e.g., the second mode of operation) by orienting the strange side 250 in the predetermined direction (930). A user can control various aspects of a media player while operating the multi-modal input device 200 in the second mode of operation (940). In certain embodiments, a user can play or pause a media file, select the next or previous track in a plurality of media files, and control the media volume, fader, panning, base, treble, and the like. The media controller mode of operation is further described above with respect to FIGS. 7A and 7B.

Referring back to the method 900, a user can change (945) the multi-modal input device 200 from the second mode of operation (e.g., media controller mode) to a third mode of operation (e.g., picture mode) by orienting the left side 230 in the predetermined direction (950). In certain embodiments, a user can perform a variety of image controls while operating in the picture mode including browsing, panning, and zooming functions (960). The picture mode of operation is further described above with respect to FIG. 6.

In some embodiments, the user can change (965) the multi-modal input device 200 from the third mode of operation (e.g., picture mode) to a fourth mode of operation (e.g., presentation mode) by lifting the multi-modal input device 200 off of a surface (970). In certain embodiments, a user can perform a variety of presentation functions while operating in the presentation mode including selecting the next or previous slide in a slide presentation (e.g., Microsoft™ Powerpoint) (980). A user can further toggle between a full screen and blank screen display. The presentation mode of operation is further described above with respect to FIGS. 8A and 8B.

It should be appreciated that the specific steps illustrated in FIG. 9 provide a particular method of switching between modes of operation, according to an embodiment of the present invention. Other sequences of steps may also be performed according in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 9 may include multiple sub-steps that may be performed in various sequences as appropriate to the individual step. Furthermore, additional steps may be added or removed depending on the particular applications. Additionally, different ways of switching between modes of operation may be possible using hardware, software, or a combination of the two. One of ordinary skill in the art would recognize and appreciate many variations, modifications, and alternatives of the method 900.

It should be noted that certain embodiments of the present invention can perform some or all of the functions described herein. For example, some embodiments can perform all of the functions described in FIGS. 1-9, while others may be limited a one or two modes of operation.

In alternative embodiments, a “shake” gesture can be incorporated into the various modes of operation. A shake gesture can be performed when a user rapidly shakes the device in short bursts. For example, a shake gesture in the mouse mode (bottom side active 220) can initiate a delete command. To illustrate, a user can highlight a passage of text in a word processing application (e.g., Microsoft™ Word) and subsequently shake the multi-modal input device 200 to delete the passage. Similarly, a user can highlight a group of files in a file management window (e.g., Windows™ Explorer) and shake the multi-modal input device 200 to send the group of files to the trash bin. It should be noted that the shake gesture in the mouse mode of operation is performed while maintaining contact between the bottom side 220 and the surface. In the media controller mode of operation (top side 210 active), a shake gesture may cause a media player to toggle between a shuffle play mode and a “normal” play mode. In further embodiments, the media player can additionally toggle between a loop playback mode with each successive shake gesture. It should be noted that the shake gesture in the media controller mode of operation is performed while maintaining contact between the strange side 250 and the surface. The shake gesture may optionally provide various novelty functions for entertainment purposes. For example, in the presentation mode (e.g., user lifts multi-modal input device 200 off of surface), a shake gesture may initiate a dice roll function in certain applications where the multi-modal input device 200 randomly generates a number between 1 and 6 (or any typical die configuration) and sends instructions to display the result on the display 120.

In further embodiments, multiple multi-modal input device 200 input devices can be configured to work together. For example, a musician may have a digital workstation with multiple multi-modal input device 200 input devices configured in a media controller mode of operation (e.g., strange side active) where each multi-modal input device 200 individually controls one of a volume, panning controls, fader controls, or equalizer controls for a particular media track. The technical details regarding tying multiple multi-modal input device 200 devices together would be understood by one of ordinary skill in the art with the benefit of this disclosure.

In other embodiments, the functions described herein can be implemented as an application in smart phones equipped with the necessary hardware (e.g., accelerometers, gyroscopes, movement tracking systems (optical tracking), and the like) to perform the various modes of operation described herein. The modes of operation (e.g., mouse mode, presentation mode, etc.) can be performed by the smart phone hardware and interpreted by a driver (i.e., software) operated by the computer system 100. Application design is outside the scope of the present invention and is not described so as to not obfuscate the novelty of the present invention.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A wireless control device comprising:
a housing including a plurality of sides; and
a control circuit coupled to the control device, the control circuit configured to operate in a plurality of modes of operation, wherein each of the plurality of modes of operation are selected by the control circuit based on an orientation of one or more of the plurality of sides.

2. The wireless control device of claim 1 wherein the plurality of sides equals six sides.

3. The wireless control device of claim 1 further comprising at least one of an accelerometer and a gyroscope coupled to the control circuit to determine the orientation of one or more of the plurality of sides.

4. The wireless control device of claim 1 wherein the plurality of sides comprise a first side and the plurality of modes of operation comprise a first mode of operation, wherein the first mode of operation is selected when the first side is facing upwards and the first mode of operation is configured to control a cursor on a visual display.

5. The wireless control device of claim 4 wherein the first mode of operation is further configured to perform at least a scroll function or a side scroll function on the display.

6. The wireless control device of claim 1 wherein the plurality of sides comprise a second side and the plurality of modes of operation comprise a second mode of operation, wherein the second mode of operation is selected when the second side is facing upwards and the second mode of operation is configured to control pan and zoom functions on a visual display.

7. The wireless control device of claim 6 wherein the second mode of operation is further configured to control navigation and selection of media files on the visual display.

8. The wireless control device of claim 1 wherein the plurality of sides comprise a third side and the plurality of modes of operation comprise a third mode of operation, wherein the third mode of operation is selected when the third side is facing upwards and wherein the third mode of operation is configured to control photo selection for a photo display application on a visual display.

9. The wireless control device of claim 1 wherein the plurality of sides comprise a fourth side and the plurality of modes of operation comprise a fourth mode of operation, wherein the fourth mode of operation is selected when the fourth side is facing upwards and wherein the fourth mode of operation is configured to control a magnitude of a parameter on a media player, wherein the magnitude of the parameter is controlled by rotating the control device around a vertical axis passing through the fourth side.

10. The wireless control device of claim 9 further comprising a switch to control at least one of a play function, a pause function, a forward control function, or a backward control, and wherein the rotating of the control device controls a volume on the media player.

11. The wireless control device of claim 1 wherein the control circuit is further configured to display the orientation of the control device on a visual display.

12. A method of using a control device, the method comprising:
orienting a first side of the control device in a predetermined direction;
operating the control device in a first mode of operation, wherein the first mode of operation is selected by the orienting of the first side of the control device in the predetermined direction;
orienting a second side of the control device in the predetermined direction;
operating the control device in a second mode of operation, wherein the second mode of operation is selected by the orienting of the second side of the control device in the predetermined direction.

13. The method of claim 12 further comprising:
orienting a third side of the control device in the predetermined direction;
operating the control device in a third mode of operation, wherein the third mode of operation is selected by the orienting of the third side of the control device in the predetermined direction.

14. The method of claim 13 further comprising:
orienting a fourth side of the control device in the predetermined direction;
operating the control device in a fourth mode of operation, wherein the fourth mode of operation is selected by the orienting of the fourth side of the control device in the predetermined direction.

15. The method of claim 12 wherein the first mode of operation performs at least one of controlling a cursor on a visual display, scroll function, and side scroll function on a visual display, and wherein the second mode of operation performs at least one of controlling navigation and selection of media files on the visual display and controlling a magnitude of a parameter on a media player by rotating the control device.

16. A control device comprising:
a first modality;
a second modality, wherein the first modality is configured to perform a plurality of mouse functions and the second modality is configured to perform a plurality of presentation functions; and
a means for selecting each of the first modality and second modality.

17. The control device of claim 16 further comprising a means for determining an orientation of the control device, wherein the plurality of mouse functions are selected based on the orientation of the control device.

18. The control device of claim 17 wherein the presentation functions include a means for selecting a next slide or a previous slide in a presentation.

19. The control device of claim 17 further comprising:
a first side;
a first orientation, wherein the first orientation is selected when the first side is facing a predetermined direction;
a second side;
a second orientation, wherein the second orientation is selected when the second side is facing the predetermined direction;
a third side; and
a third orientation, wherein the third orientation is selected when the third side is facing the predetermined direction.

20. The control device of claim 19 wherein the plurality of mouse functions include one or more of cursor control on a visual display, pan and zoom controls, or media controls.
